(19) United States
(12) Patent Application Publication
(10) Pub. No.: US 2007/0029754 A1
(43) Pub. Date: Feb. 8, 2007

(54) Tension adjusting device for a transmission system of a bicycle

(76) Inventor: Wen-Pin Chang, Taichung (TW)

Correspondence Address: Wen-Pin Chang, P.O. BOX 55-124, Taichung, TW

(21) Appl. No.: 11/194,686

(22) Filed: Aug. 2, 2005

(51) Int. Cl. B62K 5/00

(52) U.S. Cl. 280/284

(57) ABSTRACT

A tension adjusting device for a transmission system of a bicycle includes a rear frame pivotally and linearly mounted to a front frame of the bicycle, the rear frame including a pair of arms parallel to each other and connected to each other. Each arm includes a rear end for mounting a the rear wheel of the bicycle and a front end extending to the front frame of the bicycle and connected by an axle that is pivotally mounted in a the front frame. An adjuster is mounted between the two arms. The adjuster includes a linkage includes a lower end pivotally connected to the two arms and a bolt screwed through an upper end of the linkage and extends into the front frame to make the upper end of the linkage abut against the front frame due to a gravity from the bicycle.

### BACKGROUND OF THE INVENTION

1. Field of the Invention

The present invention relates to a tension adjusting device, and more particularly to a tension adjusting device for a transmission system of a bicycle.

2. Description of Related Art

A bicycle with a conventional tension adjusting device for a transmission system thereof in accordance with the prior art shown in FIGS. 1 and 2 comprises front frame (1), a rear frame (2) linearly extending from the front frame (1) and the transmission system (3) is mounted on the front frame (1) and the rear frame (2). The transmission system (3) has a drive gear (302) pivotally mounted to a lower portion of the front frame (1), a sprocket (304) laterally and centrally mounted to an axle (not numbered) that pivotally supports the rear wheel (4) of the bicycle and an endless chain (306) surrounding the drive gear (302) and the sprocket (304). The rear frame (2) is formed with a pair of arms (202). Each arm (202) has a seat (204) formed on a free end thereof. A groove (2042) is defined in each of the seat (204) and backward extends to a rear end of each of the seat (204).

The axle, which supports the rear wheel (4) of the bicycle, extends through the groove (2042) of each of the seats (204). Two holders (5) respectively sleeved on two opposite ends of the axle. Each holder (5) has a threaded rod (502) extending therefrom and parallel to a corresponding one of the two grooves (2042). Each threaded rod (502) has a washer (504) sleeved thereon and abutting against the rear end of each of the two seats (204), and a bolt (506) screwed thereunto such that the holder (5) will backward pull the axle to make the axle moved within the grooves (2042) for adjusting the tension of the endless chain (306) when tightly screwing the bolts (506).

When adjusting the tension of the endless chain (306) of the transmission system, the operator needs to screw the two bolts (506) and rotate the rear wheel (4) at the same time to ensure that the rear wheel (4) is in a perpendicularly condition. However, the two bolts (506) usually can not be once screwed to the right position. The operator needs to continually adjust and ride till the tension of the endless chain (306) is adjusted to the purposed level. In addition, the operator needs to forward push the rear wheel (4) when the tension of the endless chain (306) is too tight. It is very inconvenient.

The present invention has arisen to mitigate and/or obviate the disadvantages of the conventional tension adjusting device for a transmission system of a bicycle.

### SUMMARY OF THE INVENTION

The main objective of the present invention is to provide an improved tension adjusting device for a transmission system of a bicycle, which is easily and rapidly operated.

To achieve the objective, the tension adjusting device in accordance with the present invention comprises a rear frame pivotally and linearly mounted to a front frame of the bicycle, the rear frame including a pair of arms parallel to each other and connected to each other. Each arm includes a rear end for mounting a the rear wheel of the bicycle and a front end extending to the front frame of the bicycle and connected by an axle that is pivotally mounted in a the front frame. An adjuster is mounted between the two arms. The adjuster includes a linkage includes a lower end pivotally connected to the two arms and a bolt screwed through an upper end of the linkage and extends into the front frame to make the upper end of the linkage abut against the front frame due to a gravity from the bicycle, thereby, the two arms are swung relative to the front frame to adjust the tension of the transmission system of the bicycle when the bolt is rotated to adjust a distance between the upper end of the linkage and the front frame.

Further benefits and advantages of the present invention will become apparent after a careful reading of the detailed description with appropriate reference to the accompanying drawings.

### BRIEF DESCRIPTION OF THE DRAWINGS

FIG. 1 is a right side view of a conventional tension adjusting device for a transmission system of a bicycle in accordance with the prior art;

FIG. 2 is a partially enlarged view of FIG. 1;

FIG. 3 is a right side view of a tension adjusting device for a transmission system of a bicycle in accordance with the present invention;

FIG. 4 is a partially enlarged view of FIG. 3;

FIG. 5 is a first operational view of the tension adjusting device in FIG. 3;

FIG. 6 is a second operational view of the tension adjusting device in FIG. 3;

FIG. 7 is a right side view of a second embodiment of the tension adjusting device in accordance with the present invention;

FIG. 8 is a right side view of a third embodiment of the tension adjusting device in accordance with the present invention; and

FIG. 9 is a top plan view of the tension adjusting device in FIG. 8 along line 9-9.

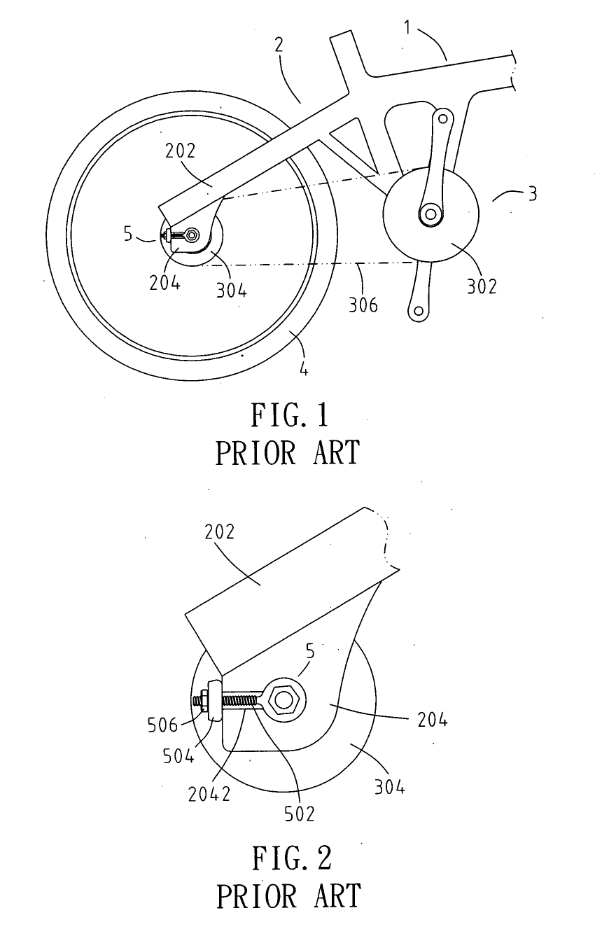

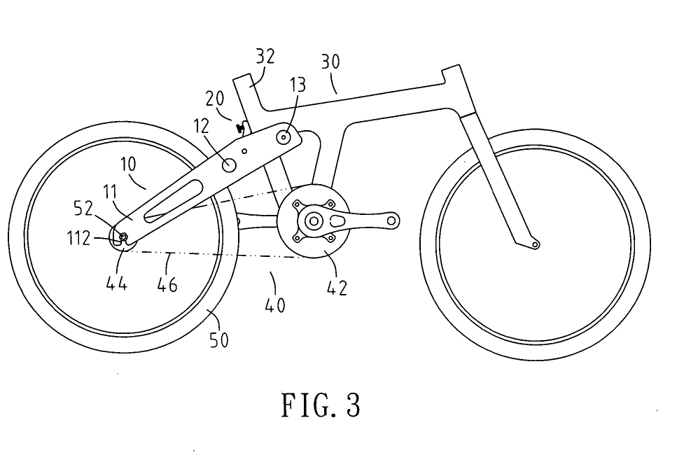

### DETAILED DESCRIPTION OF THE INVENTION

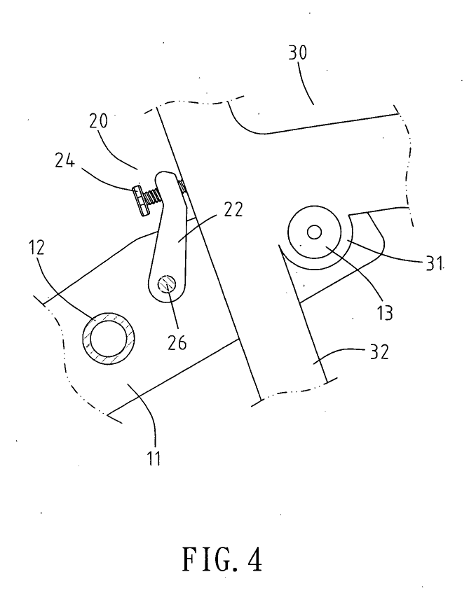

Referring to the drawings and initially to FIGS. 3 and 4, a tension adjusting device for a transmission system of a bicycle in accordance with the present invention comprises a rear frame (10) and an adjuster (20) mounted on the rear frame (10). The rear frame (10) includes a pair of arms (11) parallel to each other and connected to each other by a bridge (12) such that the pair of arms (11) is synchronously operated. Each arm (11) includes a rear end having a slot (112) defined therein for respectively receiving two opposite ends of a rear wheel axle (52) to hold the rear wheel (50) of the bicycle in place. Each arm (11) includes a front end extending to a front frame (30) of the bicycle and connected by an axle (13) that is pivotally received in a sleeve (31). The sleeve (31) is integrally formed with the front frame (30) such that the rear frame (10) can be swung relative to the front frame (30) and the axle (13) is used as a fulcrum. The adjuster (20) is disposed between the pair of arms (11) and adjacent to a stand (32) of the front frame (30). The adjuster (20) includes a linkage (22) pivotally connected to the two arms (11). The linkage (22) includes a lower end having two pivots (26) respectively laterally extending from the two opposite sides of the lower end of the linkage (22). The two pivots (26) respectively pivotally inserted into a corresponding one of the two arms (11). A bolt (24) is screwed through an upper end of the linkage (22) and extends into the stand (32) of the front frame (30) to make the upper end of the linkage (22) abut against the stand (32) due to a gravity from the bicycle. Consequently, the two arms (11) are swung relative to the front frame (30) to adjust the tension of the transmission system of the bicycle when the bolt (24) is rotated to adjust a distance between the upper end of the linkage (22) and the stand (32) of the front frame (30).

The transmission system of the bicycle comprises a drive gear (41) disposed on a lower portion of the front frame (30), a sprocket (44) is pivotally and laterally mounted on one end of the rear wheel axle (52) and an endless chain (46) surrounding the drive gear (42) and the sprocket (44). The two opposite ends of the rear wheel axle (52) are securely received in the slot (112) of each of the pair of arms (11) such that the two opposite ends of the rear wheel axle (52) horizontally correspond to each other. As a result, the operator does not need to adjust the position of the rear wheel axle (52) in the slot (112).

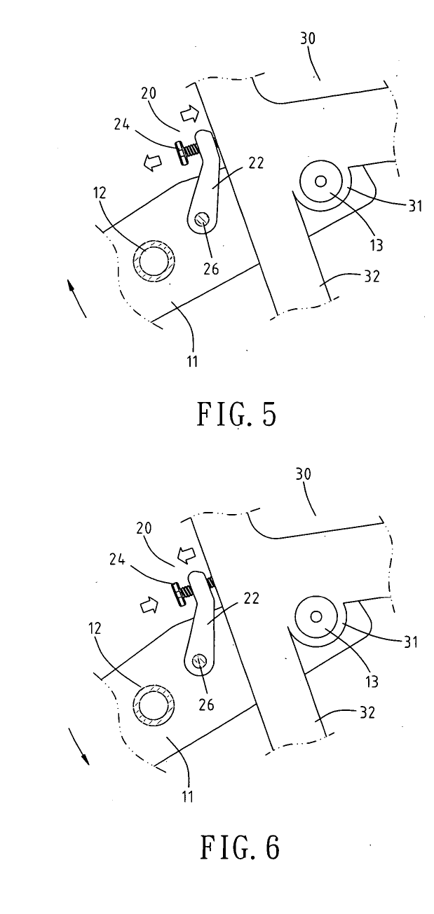

With reference to FIGS. 3 and 5, when tightly adjusting the tension of the transmission system of the bicycle, the bolt (24) is reversely screwed relative to the linkage (22) such that the distance between the bolt (24) and the stand (32) is widened. Consequently, the rear frame (10) is upwardly and circuitously moved and the axle (13) is used as a center when the linkage (22) abuts against the stand (32) again. As a result, the distance between the drive gear (42) and the sprocket (44) is elongated such that the tension of the endless chain (46) is raised and the sensitivity of the transmission system of the bicycle is promoted.

With reference to FIGS. 3 and 6, when loosely adjusting the tension of the transmission system of the bicycle, the bolt (24) is inward screwed relative to the linkage (22) such that the distance between the bolt (24) and the stand (32) is shortened. Consequently, the rear frame (10) is downward and circuitously moved and the axle (13) is used as a center when the linkage (22) abuts against the stand (32) again. As a result, the distance between the drive gear (42) and the sprocket (44) is shortened such that the tension of the endless chain (46) is loosed and the sensitivity of the transmission system of the bicycle is degraded.

As described above, the present invention comprises a pivotal rear frame (10) and an adjuster (20) such that the operator only needs to reversely/inward screw the bolt (24) for easily and rapidly adjusting the tension of the transmission system of the bicycle without changing the position of the rear wheel (50). In addition, a tool is unnecessary to rotate the bolt (24) and the operator can fine adjust the tension of the transmission system of the bicycle by using the bolt (24). Consequently, the operation of adjusting the tension of the transmission system of the bicycle becomes convenient and fine due to the present invention.

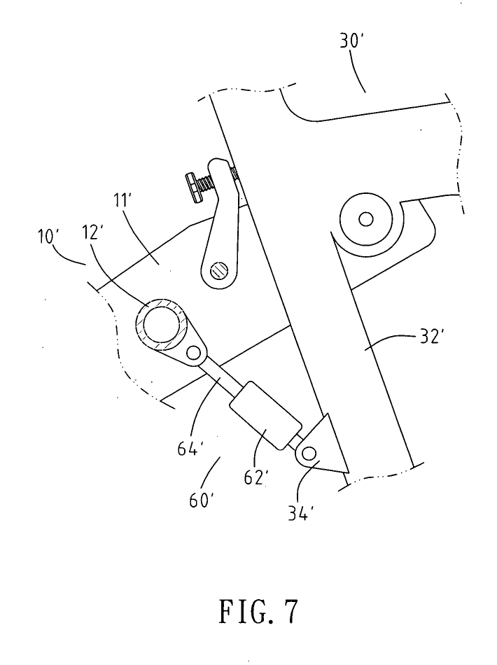

With reference to FIG. 7 that shows a second embodiment of the tension adjusting device for a transmission system of a bicycle in accordance with the present invention, the tension adjusting device further comprises a supporter (60′) having two opposite ends respectively pivotally connected to the front frame (30′) and the rear frame (10′). The supporter includes a cylinder (62′) and a piston (64′) partially reciprocally moved in the cylinder (62′). The cylinder (62′) has a lower end pivotally connected to a connector (34′) that extending from the stand (32′) and the piston (64′) has a free end pivotally connected to the bridge (12′). The piston (64′) is previously pressed when the supporter (60′) is mounted between the front frame (30′) and the rear frame (10′) for providing stable connection between the front frame (30′) and the rear frame (10′) when the rear frame (10′) lose the gravity from the bicycle, such as the bicycle. Furthermore, the supporter (60′) can be a resilient element, such as a spiral spring or a curved spring plate.

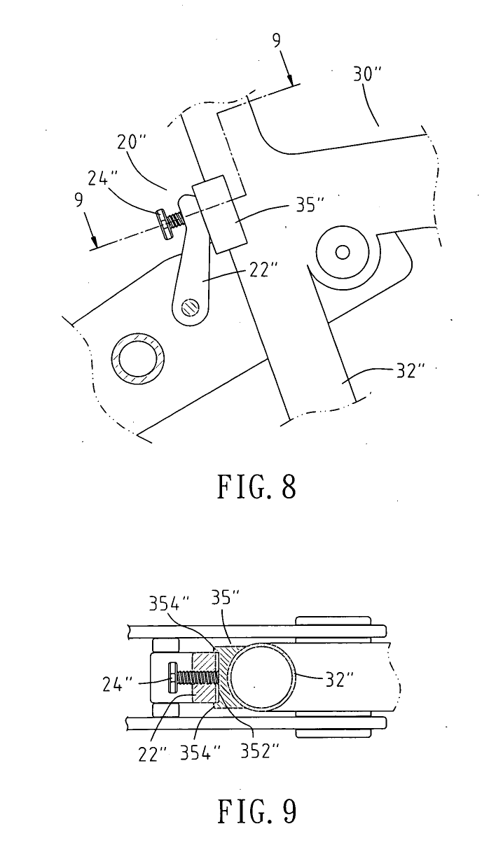

With reference to FIGS. 8 and 9 that show a third embodiment of the tension adjusting device for a transmission system of a bicycle in accordance with the present invention, a seat (35″) is disposed on a back of the stand (32″) and corresponds to the adjuster (20″). The seat (35″) is formed with a plane (352″) facing the adjuster (20″). In the preferred embodiment of the present invention, the plane (352″) is perpendicular to an axis of the bolt (24″) for the free end of the bolt (24″) to stably abut the stand (32″) and promote the operating reliability of the adjuster (20″). In addition, the seat (34″) has two walls (354″) extending from two opposite sides of the plane (352″) to protect and guide the linkage (22″) for promoting the operating reliability of the adjuster (20″).

Although the invention has been explained in relation to its preferred embodiment, it is to be understood that many other possible modifications and variations can be made without departing from the spirit and scope of the invention as hereinafter claimed.

What is claimed is:

1. A tension adjusting device for a transmission system of a bicycle, comprising:
a rear frame adapted to be pivotally and linearly mounted to a front frame of the bicycle, the rear frame including a pair of arms parallel to each other and connected to each other by a bridge such that the pair of arms is synchronously operated, each arm including a rear end adapted for mounting a the rear wheel of the bicycle and a front end extending to the front frame of the bicycle and connected by an axle that is pivotally mounted in a the front frame; and
an adjuster mounted between the two arms of the rear frame, the adjuster including a linkage includes a lower end pivotally connected to the two arms and a bolt screwed through an upper end of the linkage and extends into the front frame to make the upper end of the linkage abut against the front frame due to a gravity from the bicycle, thereby, the two arms are swung relative to the front frame to adjust the tension of the transmission system of the bicycle when the bolt is rotated to adjust a distance between the upper end of the linkage and the front frame.

2. The tension adjusting device as claimed in claim 1 further comprising a supporter having two opposite ends respectively pivotally connected to the front frame and rear frame for promoting the operating reliability of the adjuster.

3. The tension adjusting device as claimed in claim 2, wherein the supporter includes a cylinder and a piston partially reciprocally moved in the cylinder, the cylinder having a lower end pivotally connected to the front frame and the piston having a free end pivotally connected to the bridge.

4. The tension adjusting device as claimed in claim 3, wherein the piston is previously pressed when the supporter is mounted between the front frame and the rear frame for providing stable connection between the front frame and the rear frame when the rear frame lose the gravity from the bicycle.

5. The tension adjusting device as claimed in claim 2, wherein the supporter is a spiral spring.

6. The tension adjusting device as claimed in claim 5, wherein the spiral spring is previously pressed when the spiral spring is mounted between the front frame and the rear frame for providing stable connection between the front frame and the rear frame when the rear frame lose the gravity from the bicycle.

7. The tension adjusting device as claimed in claim 2, wherein the supporter is a curved spring plate.

8. The tension adjusting device as claimed in claim 2, wherein the cylinder has a lower end pivotally connected to a connector that extending from the stand.

9. The tension adjusting device as claimed in claim 1, wherein the lower end of the linkage has two pivots respectively laterally extending from the two opposite sides of the lower end of the linkage, the two pivots respectively pivotally inserted into a corresponding one of the two arms for pivotally connecting the linkage and the pair of arms.

10. The tension adjusting device as claimed in claim 1, wherein the rear end of each of the pair of arms has a slot defined therein for respectively receiving two opposite ends of a rear wheel axle of the bicycle to hold the rear wheel of the bicycle in place such that the two opposite ends of the rear wheel axle horizontally correspond to each other.

11. The tension adjusting device as claimed in claim 1, wherein the axle is pivotally received in a sleeve that is integrally formed with the front frame such that the rear frame can be swung relative to the front frame and the axle is used as a fulcrum.

12. The tension adjusting device as claimed in claim 1, wherein the bolt is screwed through an upper end of the linkage and extends into a stand of the front frame to make the upper end of the linkage abut against the stand due to the gravity from the bicycle.

13. The tension adjusting device as claimed in claim 1 further comprising a seat disposed on a back of the front frame and corresponding to the adjuster, the seat formed with a plane facing the adjuster for a free end of the bolt to stably abut the front frame and promote the operating reliability of the adjuster.

14. The tension adjusting device as claimed in claim 13, wherein the seat is disposed on a back of a stand of the front frame.

15. The tension adjusting device as claimed in claim 13, wherein the plane of the seat perpendicularly corresponds to an axis of the bolt for the free end of the bolt to stably abut the seat and promote the operating reliability of the adjuster.

16. The tension adjusting device as claimed in claim 13, wherein the seat has two walls extending from two opposite sides of the plane to protect and guide the linkage for promoting the operating reliability of the adjuster.

17. The tension adjusting device as claimed in claim 16, wherein the seat is disposed on a back of a stand of the front frame.
